(19) United States
(12) Patent Application Publication
(10) Pub. No.: US 2024/0166261 A1
(43) Pub. Date: May 23, 2024

(54) ADJUSTABLE TRANSPORTATION BODY AND A METHOD THEREOF

(71) Applicant: WHEEL.ME AS, Oslo (NO)

(72) Inventor: Andreas BLOM-BAKKE, Asker (NO)

(21) Appl. No.: 18/283,115

(22) PCT Filed: Mar. 22, 2022
(86) PCT No.: PCT/EP2022/057467

§ 371 Date: Sep. 20, 2023

(30) Foreign Application Priority Data
Mar. 22, 2021 (NO) 20210363

(51) Int. Cl. B62D 21/14; B62D 63/02

(52) U.S. Cl. CPC B62D 21/14; B62D 63/02

(57) ABSTRACT

An adjustable transportation body for transportation on a surface comprises a frame with at least four side beams forming a rectangle and at least four rolling devices connected to the transportation body. Each side beam comprises at least two telescoping elements slidable relative one another between a retracted position and an extended position and an actuator unit configured to cause the at least two telescoping elements to slide relative one another based on the input from a user device.

### TECHNICAL FIELD

The present invention concerns an automatically adjustable transportation body, for example for use in a transportation assembly for transportation of an object on a surface.

The transportation assembly may be suitable for mounting or integration to/into the object for enabling the movement of the object along a surface, or the transportation assembly may be a separate device for transportation of objects.

The invention is suitable for moving all kinds of objects that is to be moved between different locations both indoors and outdoors, where the movement is to occur along a surface, for instance a floor.

### BACKGROUND

There are a number of circumstances where there is a need for moving various devices, such as and especially furniture, may be provided with wheels or roller elements for facilitating the movement of devices from one location to another, for instance for regrouping devices or moving a device to get access to the space the device occupies or to provide access to the device itself.

The applicant has previously developed a rolling device capable of being integrated in devices, such as a piece of furniture, a movable wall etc., for moving the device along a surface. The rolling device facilitates the moving of an object and can be used by everyone regardless of physical condition and capacity to lift different devices in which the rolling device is integrated. This device is described in Norwegian Patent NO 316760 B 1.

The rolling device of NO 316760 B 1 comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

In a further version as described in WO 2018138320, the applicant has evolved the concept of the rolling device further. WO 2018138320 presents a rolling device for arrangement for autonomously moving a device from a first position to a second position along a surface. The rolling device controls the movements of a rolling element according to position acquisitions and given position and movement instructions. The rolling element may have a set or fixed vertical position relative to the rolling device or may be arranged for displacement between a retracted position where the wheel element is prevented from moving along a surface and an extended position where the wheel element is prepared for movement along the surface, as described in EP 3102429 and NO 316760 B 1.

In NO 20201025 it is described a transportation assembly for transportation of an object on a surface which comprises rolling devices, a transportation body and at least one interface element for each rolling device, where the interface element is adapted for connecting the rolling device to the transportation body.

The described devices and systems can for example be used Autonomous Mobile Robots (AMR). An AMR is a robot in which operation occurs without direct driver input or pre-configured scripts to control the steering, acceleration, and braking. Within an industrial environment, an AMR utilizes sensors and navigation algorithms to dynamically move through facilities, infrastructure-free and Machine learning capabilities may enable the robot to become more efficient and accurate as it encounters new situations. This enables the AMR to automatically adjust to meet changing environments without monitoring.

WO2020196733A1 describes a work device that is provided with cylindrical rotating bodies that can be configured to be expanded and contracted based on the application for which the work device is employed such as mowing, pruning, felling, ploughing or removing snow.

The object of the invention is to provide an adjustable transportation body, for example for use along an AMR or other kind of transportation assembly for transportation of an object on a surface.

Another object of the invention is to provide a transportation means which can be used for a variety of objects, which is easy to adapt automatically to the specific needs of a user.

A further object of the invention is to provide a transportation assembly for transportation of an object on a surface and an interface element for mounting or integration to/into an object that provides flexible transportation of various objects.

The object of the invention is achieved by means of the features of the patent claims.

### SUMMARY OF THE INVENTION

An adjustable transportation body for transportation on a surface comprises in one embodiment a frame with at least four side beams forming a rectangle and at least four rolling devices connected to the transportation body. Each side beam comprises at least two telescoping elements slidable relative one another between a retracted position and an extended position and the adjustable transportation body comprises an actuator unit that controls the actuator and configured to cause the at least two telescoping elements to slide relative one another based on the signals from a central control unit within the adjustable transportation body.

In one embodiment the actuator unit may comprise an actuator and an actuator rod. The actuator is a linear actuator, for example a mechanical linear actuator. Mechanical linear actuators typically operate by conversion of rotary motion into linear motion. Conversion is commonly made via a few simple types of mechanism:

Screw: leadscrew, screw jack, ball screw and roller screw actuators all operate on the principle of the simple machine known as the screw. By rotating the actuator's nut, the screw shaft moves in a line.

Wheel and axle: Hoist, winch, rack and pinion, chain drive, belt drive, rigid chain and rigid belt actuators operate on the principle of the wheel and axle. A rotating wheel moves a cable, rack, chain or belt to produce linear motion.[1]

Cam: Cam actuators function on a principle similar to that of the wedge, but provide relatively limited travel. As a wheel-like cam rotates, its eccentric shape provides thrust at the base of a shaft.

In one embodiment the linear actuator has an actuator rod movable into and out of an actuator unit.

In an embodiment according to the invention, the actuator may be an automatically controlled actuator, based on the signals from a user device. The actuator may comprise an actuator unit with an actuator rod within, a central control unit that provides signals for controlling the actuator unit. Further, based on the signals obtained from the central control unit the actuator unit may send signals to a telescopic elements control unit to configure the telescopic elements as per a set of dimensions entered by a user on a user device.

The adjustable transportation body may further comprise interface elements mounted on the transportation body adapted for receiving and connecting each rolling device to the transportation body.

Each rolling device comprises in some embodiments driving means, communication means, and sensors for autonomous operation when controlled by a central control unit.

The rolling device may be mecanum wheels that facilitate omnidirectional movement of the wheels. This allows for adjustment and movement of transportation assembly as desired by the user. On obtaining the user input dimensions, the central control unit also sends signals to the mecanum wheels to adapt according to the dimensions from the user. The omnidirectional properties enables the mecanum wheels to move to adapt the length and width while keeping the frame of the transportation assembly in stationary position as relative to the wheels. This enables the transportation assembly to be moved in any direction as desired by the user.

The side beams may also comprise locking elements for locking the telescoping elements in a fixed position.

In one configuration, the at least two side beams comprise three telescoping elements, where one middle element can slide inside the two outer elements based on the signals from the actuator unit that is further controlled by a central control unit that receives signals from the user device.

The frame may further comprise at least one cross beams arranged across the rectangle and being arranged in parallel to two of the side beams and perpendicular to two of the other side elements and where there are arranged rolling devices at each corner where two perpendicular beams meet.

The adjustable transportation body may comprise sensors for detecting the position of the transportation body.

### BRIEF DESCRIPTION OF THE DRAWINGS

The invention will now be described in more detail by reference to the accompanying figures.

FIG. 1 illustrates an adjustable transportation body according to the invention.

FIG. 2 illustrates an adjustable transportation body in extended state and retracted state.

FIGS. 3 and 4 shows an example of a transportation assembly with six wheels for transportation of an object on a surface.

FIG. 5 illustrates a block diagram of an automatically controlled adjustable transportation body based on a user's input.

FIG. 6 illustrates a flow diagram of the method for automatically controlling the adjustable transportation body and the telescopic elements based on user's input.

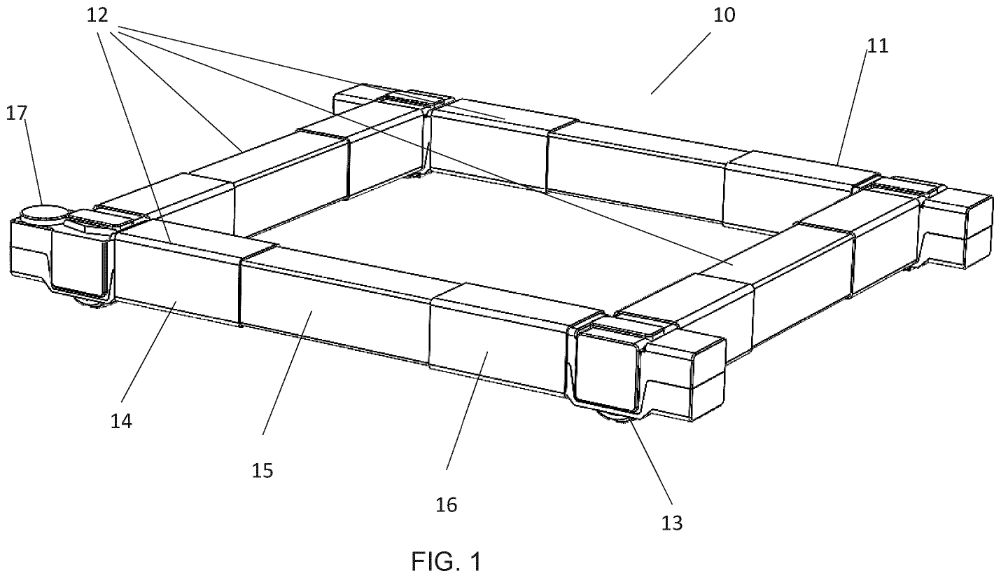

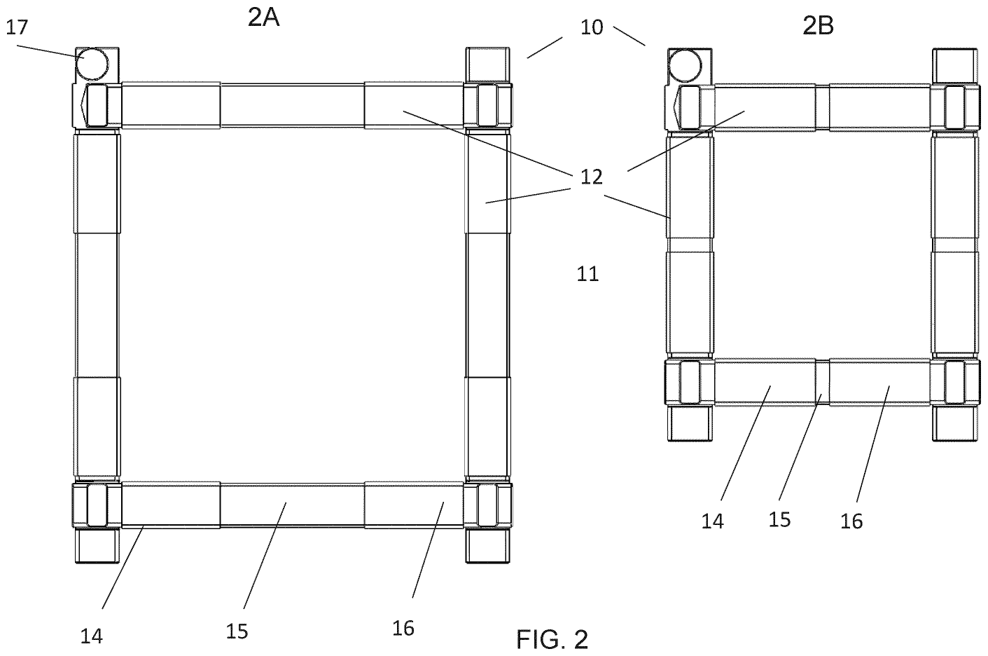

An adjustable transportation body 10 for transportation on a surface is illustrated in FIGS. 1 and 2. The adjustable transportation body 10 comprises a frame 11 with at least four side beams 12 forming a rectangle and at least four rolling devices 13 connected to the transportation body. Each of the side beams 12 comprises in the example embodiment three telescoping elements 14, 15, 16 which are slidable relative one another between a retracted position and an extended position. In other embodiments, only two of the side beams may comprise telescoping elements, and there may in some embodiments be two or more than three telescoping elements.

The three telescoping elements 14, 15, 16 have in this example a square cross section, but in other embodiments, the cross section may have other shapes such as circular, rounded or triangular. At least one of the telescoping elements 14 is hollow and has a larger inner cross section than the outer cross section of another telescoping element 15, allowing the telescoping element with the smaller cross section to slide inside the telescoping element with the larger cross section. In the illustrated example the three telescoping elements 14, 15, 16 comprises one middle element 15 and two outer elements 14, 16, where the outer elements are hollow. The outer cross section of the middle element 15 is smaller than the inner cross section of the outer elements 14, 16, allowing the middle element to slide inside the outer elements.

In this way, the side beams 12 of the frame 11 can be extended or retracted, thus changing the shape and size of the adjustable transportation body 10. In FIG. 2a the four side beams are all in an extended state with the telescoping elements slid to an extended position. In FIG. 2b the side beams are all in the retracted state with the telescoping elements 14, 15, 16 in the retracted position. As can be seen from the figures, the width and length of the transportation body 10 is significantly larger in FIG. 2a than in FIG. 2b. It is of course possible to slide the elements to any intermediate position between the two extremes. It is not necessary to extend all or none of the telescoping elements, for example can only two parallel beams be extended while the other two are retracted.

As the size of the side beams can be changed in this way, the adjustable transportation body 10 can be adapted to different environments and the same transportation body be used in narrow passages and in rooms where there is more space. For example, can two parallel beams be retracted when the adjustable transportation body passes through a door and then extended when the door has been passed. The side beams may in some embodiments comprise locking elements for locking the telescoping elements in a fixed position for situations where it is desired that the side beams maintain the desired length.

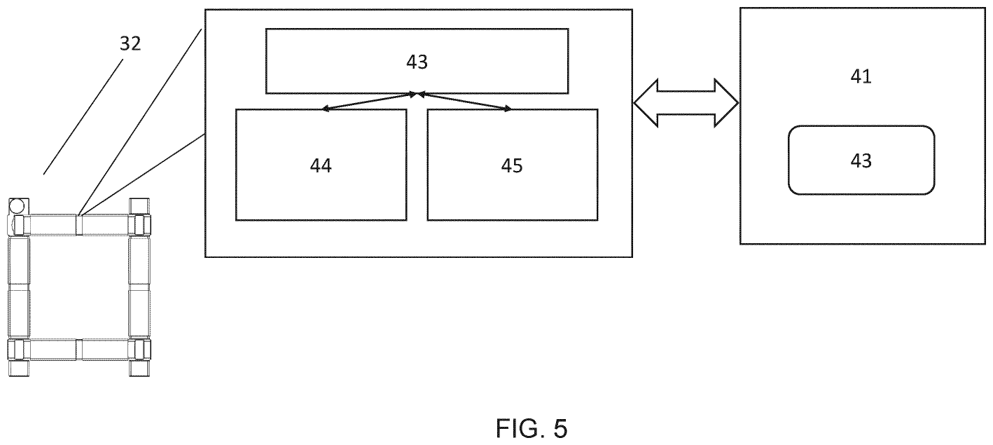

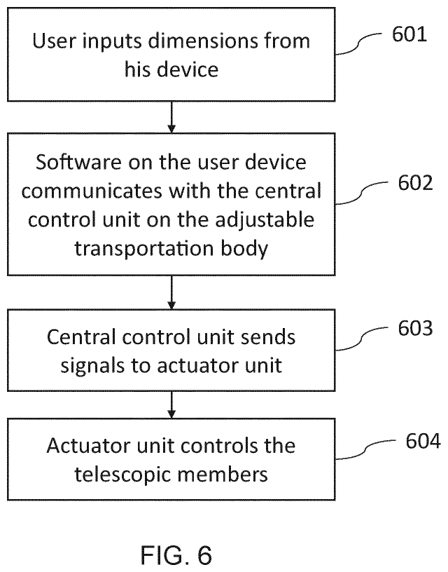

The adjustable transportation body 10 can comprise an actuator configured to cause telescoping elements to slide relative to one another. The actuator is for example a linear actuator configured to move the elements or an automatic actuator the details of which will be discussed later in FIG. 5 and FIG. 6. The linear actuator may for example have an actuator rod movable into and out of an actuator unit. The actuator rod and the actuator may then be connected each to a telescoping element so that the relative movement is actuated when operating the actuator. The actuator can comprise communication means for receiving control signals with instructions for sliding the telescoping elements to a desired position such as the retracted position, the extended position or a position between these two extreme positions. The control signals may for example be sent by a user from a user device.

The rolling devices can comprise driving means, communication means, and sensors for autonomous operation when controlled by a central control unit. This means that the adjustable transportation body can be an autonomous transportation body able to navigate through different environments. The same central control unit can control also the actuator.

The rolling devices 13 may be mecanum wheels that are controlled by the central control unit and allow the transportation body to be moved in any direction due to their omnidirectional properties and adjusted based on the user instructions. The mecanum wheels also facilitate easy navigation of the transportation body through rough surfaces, narrow spaces and change in configuration such a length and width on the go while maintaining the frame 11 of the transportation assembly stationary.

To facilitate the navigation, the adjustable transportation body comprises a sensor 17 for detecting the position of the transportation body. Data from the sensors may be used in the central control unit for navigation and to determine the size and shape of the transportation body 10, or the data may be sent to a remote receiver such as the user device for monitoring the adjustable transportation body.

There are different ways of detecting and acquiring the position of a rolling device 13 and/or the transportation body. One way is by using internal means, e.g. motion detection sensors, installed in the rolling device 13. Another way is by using external means such as a camera or by using Lidar for measuring the distance from a reference point to the rolling device 13. Another example is to use an RFID chip connected to the rolling device 13 or to the adjustable transportation body 10. Yet another way is by using ultrasound transmitter or a Bluetooth transmitter connected to the rolling device 13 for determining the position of the rolling device 13. Accurate position can then be found by means of triangulation.

Internal sensors and position detection devices may keep track of the position of a rolling device 13 in the area it is operating. Wheel encoders and inertial measurement units (IMU) can be used as motion detection sensors and odometry can be used for determining a current position based on generated data from the sensors.

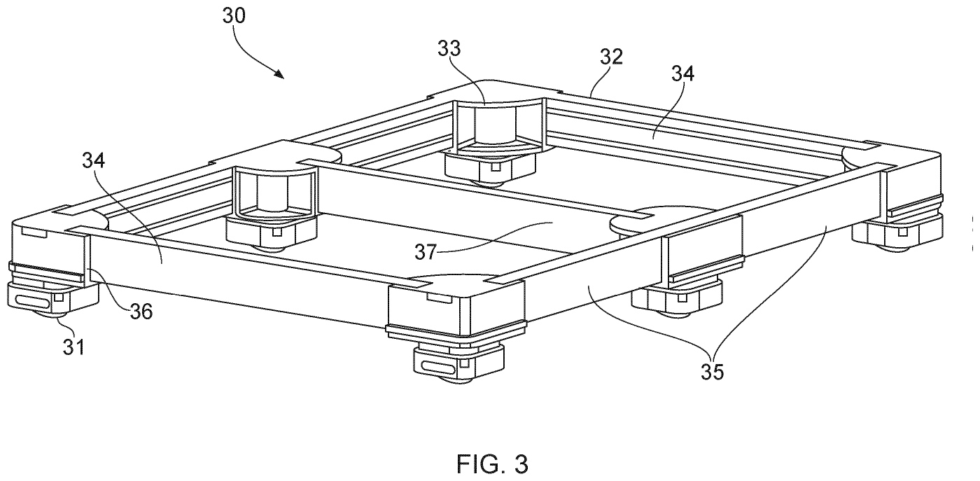

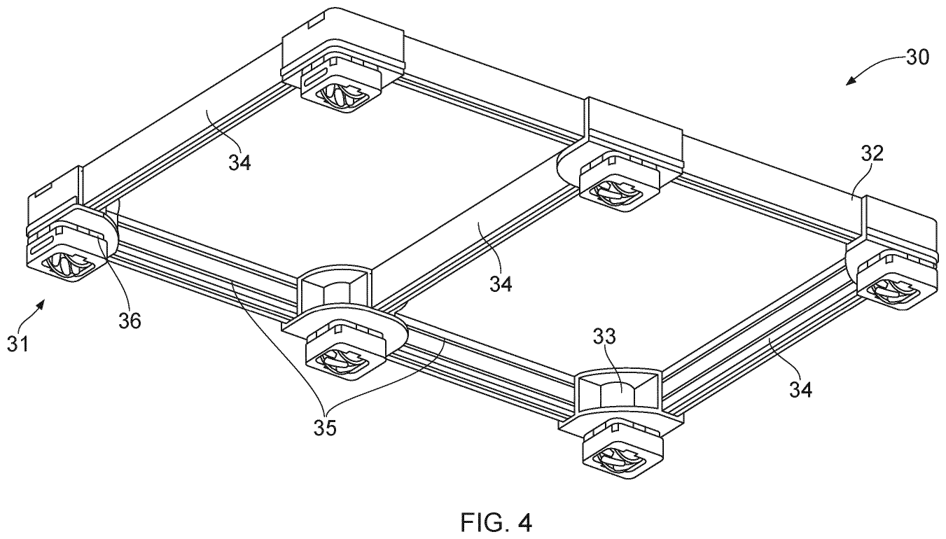

FIGS. 3 and 4 shows an example of a transportation assembly 30 for transportation of an object on a surface. The transportation assembly 30 comprises in this example six rolling devices 31, a transportation body 32, and interface elements 33 for connecting the rolling devices 31 to the transportation body 32. The number of rolling devices may be adapted to the intended use and may in other configurations be more or less than six. Higher number of rolling devices may be used in order to be able to transport more weight or larger objects. In this example, the transportation body 32 comprising a cross beam 37 arranged across the rectangle and being arranged in parallel to two of the side beams 34 and perpendicular to two of the other side beams 35 and where there are arranged rolling devices at each corner where two perpendicular beams meet.

In the embodiment as shown in FIGS. 3 and 4, the rolling devices 13 are mecanum wheels, which due to their omnidirectional movement allow the transportation body to be moved in any direction by adapting the wheels to move as per the user's input dimensions in correspondence to the telescopic guiding elements while maintaining the transportation assembly frame relatively stationary in comparison to the wheels.

The transportation body 32 comprises in this example elongated profiles 34, 35, each having two ends, where each end comprises attachment means 36 adapted to be connected to the interface element.

In this embodiment the attachment means 36 are corner elements adapted to be connected to the ends of the elongated profiles. The corner elements will be described in more detail below.

The elongated profiles 34, 35 and the corner elements 36 form together the frame, which in this embodiment is the transportation body which can support the object to be transported during transportation.

FIG. 5 illustrates a block diagram of an automatically controlled adjustable transportation body based on a user's input. As shown is an expanded view of the adjustable transportation body 10 with its control elements for controlling the extension and retraction of the telescopic elements. The adjustable transportation body 10 comprises a central control unit 44, an actuator unit 43 and a telescopic elements control unit 45 within the assembly. These elements allow for automatic adjustment and control of the telescopic elements 14, 15 and 16 by sliding the telescopic elements 14, 15, 16 in relation to the mecanum wheels 13 movement to attain dimensions as specified or input by a user on a user device 41. In an embodiment, of this example the user device 41 is a mobile device, tablet, computer etc and may be configured with a software 43 on the user device 41. The software 43 may be a program installed or downloaded or may be an app on the user device 41.

Once the user determines the dimensions of the article or goods he/she would like to move employing the adjustable transportation body 10, the user may enter the dimensions for example, length and width (breadth) on the software 43 on the user device 41. Based on the entered dimensions the software 43 communicates with the central control unit 44 on the transportation assembly 10 by sending signals wirelessly or other known communication mechanisms in the field. The central control unit 44 on obtaining the signals communicates with and controls the actuator unit 43 to adjust the positions of the telescopic elements 14, 15, 16 based on the dimensions entered by the user. The central control unit 44 also sends signals to the mecanum wheels 13 to adjust their movement based on the length and width input. The mecanum wheels moves to adapt their position in relation to the frame of the transportation body. Finally, the telescopic elements control unit 45 may perform the actual adjustment of the telescopic elements to attain the desired dimensions input by the user.

In an embodiment, the user may also input the height of the object in addition to the length and width of the object so that the transportation body 10 is also adjusted to facilitate the movement of the specified object based on its length, width and height. This feature is made possible by the omnidirectional movement of the mecanum wheels 13.

In an embodiment, the user may also change the dimensions of the object on the user device 41 dynamically. In such a case, the central control unit 44 may receive signals from the user device 41 with the new dimensions. The central control unit 44 may then be able to configure the telescopic guiding elements 14, 15, 16 and the mecanum wheels 13 dynamically (i.e., during or before operation) as per the user's entered dimensions.

FIG. 6 illustrates a flow diagram of the method for automatically controlling the adjustable transportation body and the telescopic elements based on user's input. In this example, a user enters dimensions of the object he would like to move from one location to a second location on his user device (601). The dimensions entered may be length and width. Although not described in this example, it is also possible to configure the height of the transportation body 10. In step (602) the entered dimension is reviewed by the software 43 on the user device 41 to determine and verify the validity of the data. The user device 41 then sends signals to a central control unit 44 on the transportation body. The central control unit 44 then sends signals (603) to the actuator unit 43 to facilitate the actuator unit to adjust the positions of the telescopic members 14, 15, 16. The actuator moves (604) the actuator rod to adjust the positioning of the telescopic members 14, 15, 16 based on the pre-configured dimensions entered by the user. The movement is facilitated by the rolling devices (mecanum wheels which have omnidirectional properties for movement) 13 by adjusting their position in relation to the transportation assembly. The adjustable transportation body 10 is then ready to carry the desired object and move it to the desired location by the user. In an embodiment, the adjustable transportation body 10 may be configured to automatically locate itself below the object to be moved by means of autonomous rolling devices 13 as described above.

1. An autonomous mobile robot comprising an adjustable transportation body for transportation on a surface, comprising a frame with at least four side beams forming a rectangle, interface elements mounted on the transportation body adapted for receiving and connecting rolling devices to the transportation body and at least four rolling devices connected to the transportation body, where at least two of the side beams each comprises at least two telescoping elements slidable relative one another between a retracted position and an extended position and an actuator configured to cause the at least two telescoping elements to slide relative one another based on the input received from a user device, and where the rolling devices are autonomous.

2. The adjustable transportation body according to claim 1, further comprising:
a central control unit configured to receive signals from the user device;
an actuator unit that obtains signals from the central control unit to move the telescopic elements; and
a telescopic elements control unit that slides to adjust the position of the telescopic elements to an extended position or retracted position when the actuator unit moves the actuator rods.

3. The adjustable transportation body according to claim 2, wherein the input from the user device is at least one of: length, width, height of the object the transportation body is transporting.

4. (canceled)

5. The adjustable transportation body according to claim 1, where each rolling device comprises driving means, communication means, and sensors for autonomous operation when controlled by a central control unit.

6. The adjustable transportation body according to claim 1, where the actuator is a linear actuator having an actuator rod movable into and out of an actuator unit, where the actuator rod is connected to one of the telescoping elements.

7. The adjustable transportation body according to claim 1, where the actuator receives control signals with instructions for sliding the telescoping elements to the retracted position, the extended position or a position therebetween.

8. (canceled)

9. The adjustable transportation body according to claim 1 where the side beams comprise locking elements for locking the telescoping elements in a fixed position.

10. The adjustable transportation body according to claim 1 where at least one of the telescoping element is hollow and at least one of the telescoping elements have smaller outer cross section than the inner cross section of the hollow telescoping element, allowing the telescoping element with the smaller cross section to slide inside the telescoping element with the larger cross section.

11. The adjustable transportation body according to claim 1 where the at least two side beams comprise three telescoping elements, where one middle element can slide inside the two outer elements.

12. The adjustable transportation body according to claim 1, further comprising at least one cross beams arranged across the rectangle and being arranged in parallel to two of the side beams and perpendicular to two of the other side elements and where there are arranged rolling devices at each corner where two perpendicular beams meet.

13. The adjustable transportation body according to claim 1 comprising sensors for detecting the position of the transportation body.

14. The adjustable transportation body according to claim 1, where the rolling devices are mecanum wheels.

15. A method for adjusting a position of an adjustable transportation body, between an extendable position and retractable position based on input from a user, wherein the method comprises:
sending input from a user device by the user, where the input is dimensions of an object;
receiving a signal at the central control unit of the adjustable transportation body;
controlling the position of telescopic elements by an actuator unit when receiving the signal from the central control unit; and
configuring the positions of the telescopic elements based on the dimensions of the object.

16. The method in accordance with claim 15, wherein the dimensions of the object is at least one of: length, width, height.
